(19) United States
(12) Patent Application Publication
(10) Pub. No.: US 2015/0159609 A1
(43) Pub. Date: Jun. 11, 2015

(54) WEAR RESISTANT INSERT ELEMENT FOR A BAFFLE BODY AND BAFFLE BODY FOR A PLUNGER OPERATED FUEL PUMP

(71) Applicant: Caterpillar Motoren GmbH & Co. KG, Kiel (DE)

(72) Inventors: Andreas Von Der Osten-Sack, Kiel (DE); Harald Kornus, Altenholz (DE)

(73) Assignee: Caterpillar Motoren GmbH & Co. KG, Kiel (DE)

(21) Appl. No.: 14/401,625

(22) PCT Filed: May 17, 2013
(86) PCT No.: PCT/EP2013/001477

§ 371 Date: Nov. 17, 2014

(30) Foreign Application Priority Data
May 25, 2012 (EP) 12 169 619.9

(51) Int. Cl. F02M 55/00; F02M 59/02; F02M 55/04

(52) U.S. Cl. CPC F02M 55/001; F02M 55/04; F02M 59/02

(57) ABSTRACT

A wear resistant insert element is configured to be inserted into a shaft of a baffle body for a plunger operated fuel pump. The baffle body absorbs the energy of a pressure wave generated during pumping operation of the fuel pump. A wear resistant insert element may be made of ceramic and inserted into the baffle body such that an end surface of the baffle body is configured to absorb the energy of a fuel pressure wave and resist wear.

### TECHNICAL FIELD

The present disclosure generally refers to fuel pumps, and more particularly, a baffle body configured for use in a plunger operated fuel pump.

### BACKGROUND

Fuel pumps working according to the displacement principle by using a plunger are known in the art. Fuel pumps using a plunger may be, for example, displacement pressure pumps that can be used in connection with marine engines, construction machine engines, or other large engines. In the following, fuel pumps using a plunger are referred to as “plunger operated fuel pumps”.

Plunger operated fuel pumps can be operated with any kind of fuel, including alternative fuel used as a substitute for diesel fuel oil (DFO), light fuel oil (LFO) and heavy fuel oil (HFO), or low sulfur fuels.

Alternative fuels include first generation biofuels (for example, palm oil, canola oil, oils based on animal fat) and second generation bio fuels (for example, oils made of non-food corps, i.e., waste biomass). Examples of second generation biofuel include “pyrolysis oils” obtained from the pyrolysis of, for example, wood or agricultural wastes, such as the stalks of wheat or corn, grass, wood, wood shavings, grapes, and sugar cane.

The chemical composition and the physical properties of alternative fuels such as pyrolysis oils and low sulfur fuels can differ significantly from those of DFO, LFO, and HFO, in particular, with respect to the high content of water and oxygen, the acidic pH-value in the range around, for example, 2 to 3.5, and the rather low heating value. Moreover, alternative fuels and low sulfur fuels can have poor or no lubrication properties and usually comprise small size particles in the range of, for example, 0.01 to 5 μm. In addition, the temperature of use is generally lower for alternative fuels and low sulfur fuels than for, for example, HFO. A temperature of use of 60° C. is common for pyrolysis oil to provide a viscosity which is suitable for fuels to be injected into a combustion chamber of an engine.

Plunger (displacement) operated fuel pumps typically have a pump housing containing a pump barrel and a plunger arranged within the pump barrel and defining a pumping chamber. Further, plunger operated fuel pumps have a control for adjusting the fuel supply volume which is supplied from the fuel pump to the engine in accordance with a current load condition, for example, a mechanical or an electrical control.

For mechanical control, a plunger having a control edge may be used. In this case, during each pumping cycle, i.e., every time the control edge passes a fuel port through which fuel is supplied to the pumping chamber, the high pressure in the pumping chamber is transmitted to the surplus fuel not supplied to the corresponding injector of the engine. The transmission of the pressure in the pumping chamber to the surplus fuel may generate a pressure wave. Such a pressure wave propagates with high energy in the surplus fuel through the fuel pump and may cause wear along its propagation way inside the fuel pump, in particular, when impacting on the pump housing.

U.S. Pat. No. 4,640,255 discloses a plunger operated fuel pump, that uses an impact ring as a baffle component.

Further, GB 2 136 061 A discloses a plunger operated fuel pump. A substantial portion of a spill passage in the fuel pump is formed within a baffle sleeve made from a wear-resistant material such as hardened steel

The present disclosure is directed, at least in part, to improving or overcoming one or more aspects of prior systems.

### SUMMARY OF THE DISCLOSURE

According to a first aspect of the present disclosure, a wear resistant insert element is configured to be inserted into an opening of a baffle body for a plunger operated fuel pump. The wear resistant insert element comprises an impact absorbing portion with an impact absorbing surface. The impact absorbing surface is configured to at least partially absorb the energy of a pressure wave generated during pumping operation of the fuel pump.

According to a second aspect of the present disclosure, a baffle body for a plunger operated fuel pump comprises a baffle body shaft which has a fuel exposed shaft end with a shaft opening, and the above described wear resistant insert element which is inserted into the shaft opening.

According to a third aspect of the present disclosure, a fuel pump for an internal combustion engine comprises a pump housing, a barrel within the housing, a fuel supply gallery defined between the housing and the barrel, a pumping chamber defined within the barrel, at least one fuel port connecting the pumping chamber with the fuel supply gallery, and a plunger configured to move within the barrel. The above described at least one baffle body is positioned in the pump housing such that it protrudes into the fuel supply gallery at a position where, during pumping operation of the fuel pump, a pressure wave propagates towards the pump housing, wherein the impact absorbing surface of the baffle body is preferably positioned opposite to the fuel port.

According to a fourth aspect of the present disclosure, a method for increasing the wear resistance of a plunger operated fuel pump in which a fuel pressure wave is generated during pumping operation comprises the step of arranging the above described baffle body within the pump housing of a fuel pump such that the baffle body protrudes inside of the fuel pump at a position where, during pumping operation of the fuel pump, a pressure wave propagates towards the pump housing.

According to another aspect of the present disclosure, a baffle body for a plunger operated fuel pump may comprise a baffle body shaft, which has a fuel exposed shaft end with a shaft opening, and a wear resistant insert element in a axially fixed position with respect to the baffle body shaft and at least partly reaching into the shaft opening, and comprising an impact absorbing portion with an impact absorbing surface, the impact absorbing surface being configured to at least partially absorb the energy of a pressure wave generated during pumping operation of the fuel pump.

According to yet another aspect of the present disclosure, a baffle body for a plunger operated fuel pump may comprise a baffle body shaft which has a fuel exposed shaft end with a shaft opening, and a wear resistant insert element inserted into the shaft opening. The wear resistant insert element may comprise a tapered end portion, which abuts against a rear wall of shaft opening, and an impact absorbing portion with an impact absorbing surface, the impact absorbing surface being configured to at least partially absorb the energy of a pressure wave generated during pumping operation of the fuel pump.

According to a further aspect of the present disclosure, a wear resistant insert element configured to be inserted into an opening of a baffle body for a plunger operated fuel pump may comprise an impact absorbing portion with an impact absorbing surface, the impact absorbing surface being configured to at least partially absorb the energy of a pressure wave generated during pumping operation of the fuel pump, and the impact absorbing surface and the impact absorbing portion being configured to be gradually removed by abrasion if a pressure wave impinges on the impact absorbing surface.

Other features and aspects of this disclosure will be apparent from the following description and the accompanying drawings.

### BRIEF DESCRIPTION OF THE DRAWINGS

FIG. 1 is a partial cross-sectional side view of a plunger operated fuel pump;

FIG. 2 is a partial cross-sectional side view of a baffle body including a baffle body shaft and a wear resistant insert element according to a first embodiment;

FIGS. 3A and 3B are schematic side views of a wear resistant insert element according to a second embodiment;

FIGS. 4A and 4B are schematic side views of a wear resistant insert element according to a third embodiment;

FIGS. 5A and 5B are schematic side views of a wear resistant insert element according to a fourth embodiment; and

FIGS. 6A and 6B are schematic side views of a wear resistant insert element according to a fifth embodiment.

### DETAILED DESCRIPTION

The following is a detailed description of exemplary embodiments of the present disclosure. The exemplary embodiments described therein and illustrated in the drawings are intended to teach the principles of the present disclosure, enabling those of ordinary skill in the art to implement and use the present disclosure in many different environments and for many different applications. Therefore, the exemplary embodiments are not intended to be, and should not be considered as, limiting description of the scope of patent protection. Rather, the scope of patent protection shall be defined be the appended claims.

The present disclosure refers to a wear resistant insert element, which may be inserted into a baffle body shaft of a baffle body, which may be used in a fuel pump for absorbing the energy of a pressure wave generated within the fuel pump during each pumping cycle. In particular, the present disclosure refers to a fuel pump having a plunger, which may supply fuel in a pumping chamber to a fuel injector in that the plunger is axially movable within a pump barrel of the fuel pump, for example, by use of the rotational motion of a camshaft of an engine.

The present disclosure is based on the realization that in plunger operated fuel pumps which are mechanically controlled by use of a plunger having a control edge (in form of a helix), a pressure wave may be generated each time the control edge passes a fuel port through which fuel is supplied into a pumping chamber of the fuel pump. Such a pressure wave is generated, because the control edge of the plunger establishes a connection between the pumping chamber and the fuel port such that the high pressure in the fuel in the pumping chamber is transmitted to the surplus fuel in the fuel port which is not supplied to the engine. The pressure wave may propagate in the fuel through the fuel port through the fuel pump towards the outside of the fuel pump and may impact, in particular, on the housing of the fuel pump. Due to the high energy of the pressure wave, the part of the housing, which is hit by the fuel pressure wave, may be subjected to wear. In order to absorb the energy of the pressure wave and, thus, reduce the wear on the pump housing, the part of the housing, which is hit by the pressure wave, may be provided with a baffle body, for example, a baffle screw, projecting from the housing to the inside of the fuel pump, in particular the pumping chamber. The baffle body may serve as an impact absorbing element and may be made of steel. However, in case of engines operated with alternative fuels or low sulfur fuels or even sulfur-free fuels, a baffle body may be required, which resists the aggressive characteristics of such fuels, for example, the acidic pH-value and the high content of water and oxygen, in order to reduce wear and, thus, elongate the life time of the baffle body.

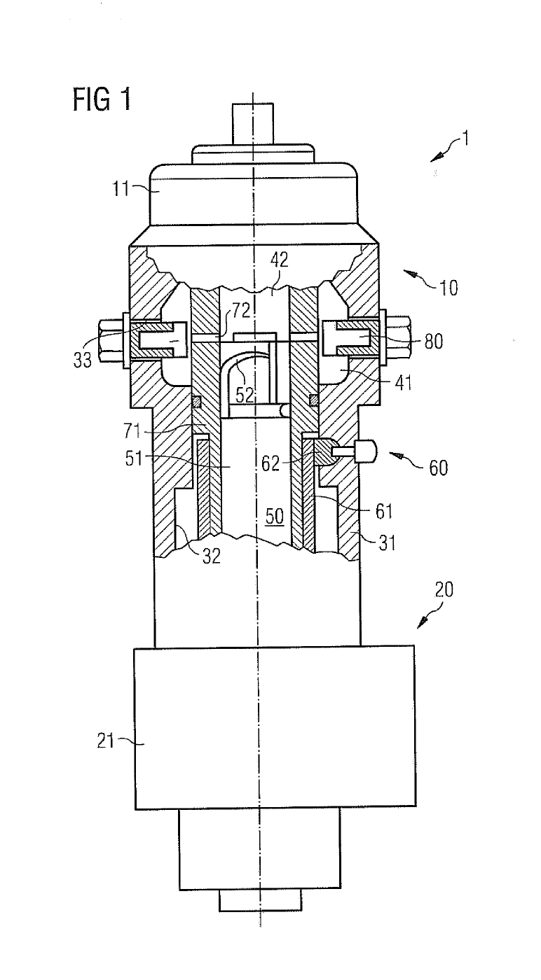

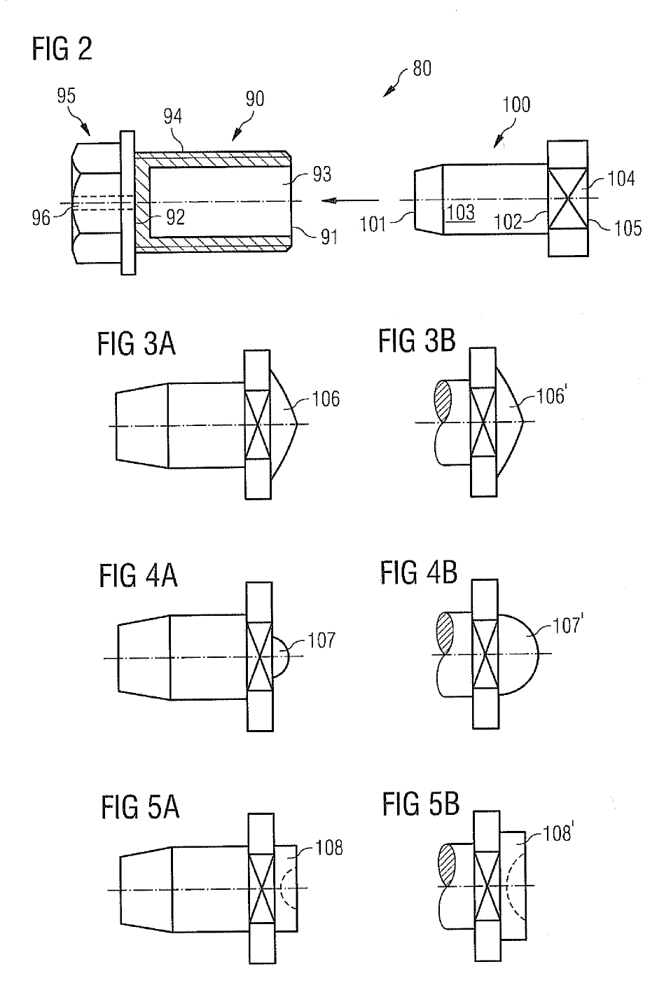

In the following, an exemplary embodiment of a fuel pump having a plunger is generally described in connection with FIG. 1. In connection with FIG. 2, an exemplary embodiment of a baffle body according to the present disclosure is described. Further, in connection with FIGS. 3A, 3B, 4A, 4B, 5A, 5B, and 6A, 6B exemplary embodiments of a wear resistant insert element to be inserted in a shaft of the baffle body are described.

In the following, “up” and “down” will be used in accordance with an upward direction and a downward direction, respectively, of FIG. 1. Similarly, “right” and “left” will be used in accordance with a right direction and a left direction, respectively, of FIG. 1, and “front” and “back” will be used in accordance with the forward direction extending out of the plane of FIG. 1 and the backward direction extending into the plane of FIG. 1. Further, “longitudinal direction” will be used in accordance with the extension of the fuel pump in the up- and down-direction of FIG. 1 and “lateral direction” will be used in accordance with the front- and back-direction of FIG. 1.

FIG. 1 shows a fuel pump 1. Fuel pump 1 may have a pump head 10 disposed in the upper part of FIG. 1. Pump head 10 may have a valve carrier 11. Further, fuel pump 1 may have a pump body 20 disposed below pump head 10. Pump body 20 may have a tappet body carrier 21 disposed in its lower part, i.e., the lower part of FIG. 1. Further, pump body 20 may have a pump housing 31 in its upper part. Pump head 10 may be adapted to be connected to a fuel injector (not shown). Pump body 20, in particular, tappet body carrier 21 may be adapted to be connected to a crank shaft (not shown) of an engine, to which fuel pump 1 supplies fuel.

Fuel pump 1 may be operated with different kinds of fuel, such as gasoline, diesel, low sulfur fuels or sulfur-free fuels, and any other fossil fuels, but also with alternative fuels, such as palm oil, canola oil, oils based on animal fat, or bio fuels such as oils made of non-food corps, i.e., waste biomass, for example, “pyrolysis oils” obtained from the pyrolysis of, for example, wood or agricultural wastes, such as the stalks of wheat or corn, grass, wood, wood shavings, grapes and sugar canes.

Pump housing 31 may be substantially cylindrical, whereas valve carrier 11 and tappet body carrier 21 may be cap-like. Valve carrier 11 may be connected to pump housing 31 by screws (not shown). Similarly, tappet body carrier 21 may be connected to pump housing 31 by screws (not shown). Additional or alternative fasting elements may be used for connecting valve carrier 11 and tappet body carrier 21 to pump housing 31.

Pump housing 31 may be a hollow cylinder, for example, pump housing 31 may have a through hole 32 extending in the longitudinal direction. In through hole 32 of pump housing 31, in a direction from the outside to the inside of fuel pump 1, a pump barrel 71 and a plunger 50 may be arranged.

Pump barrel 71 may be concentrically arranged around plunger 50. Pump barrel 71 may have two fuel ports 72 (one on the right side and one on the left side of pump barrel 71 in FIG. 1) formed in a right-left-direction through an upper part of pump barrel 71 such that the inside of pump barrel 71 may communicate with the outside of pump barrel 71. Alternatively, pump barrel 71 may be provided with only one fuel port 72 or a plurality of fuel ports 72.

Plunger 50 may extend in pump housing 31 in a longitudinal direction. Plunger 50 may be made of hardened steel, hardened steel with at least one protection layer made of DLC (Diamond-like Carbon) or WCC (Wolfram Chrome Carbide) for protecting plunger 50 and improving its tribology and/or ceramic or ceramic-like materials.

Further, plunger 50 may have a plunger shaft 51, a control edge 52 (in form of a helix) at an upper portion of plunger shaft 51 and at least one control element (not shown) at a lower portion of plunger shaft 51. Control edge 52 may be a groove formed in the upper circumferential surface of plunger 50. Control edge 52 may be curved. Alternatively, control edge 52 may also have any other configuration suitable for controlling the fuel supply volume from fuel pump 1 to an engine. The control element may be formed as an extension arranged perpendicularly to the longitudinal direction of plunger shaft 51 at its lower portion (not shown). The control element may be attached to plunger shaft 51 such that it may protrude from plunger shaft 51 perpendicularly to the longitudinal direction of plunger shaft 51.

Further, fuel pump 1 may have a control mechanism 60. Control mechanism 60 may be arranged in pump housing 31 and may have a control sleeve 61 and a control rod 62. Control sleeve 61 may be concentrically arranged around pump barrel 71 having a substantial annular cross-section. Pump barrel 71 again may be concentrically arranged around plunger shaft 51 having a substantially circular cross-section. Between pump barrel 71 and plunger shaft 51, a very small gap, for example, a clearance, may exist. Control sleeve 61, pump barrel 71, and plunger shaft 51 may extend in an up- and down-direction in FIG. 1. Control sleeve 61 may have teeth at least partway around its outer circumferential surface (not shown). Control rod 62 may be arranged in a front- and back-direction in FIG. 1 in a part of pump housing 31 and, hence, perpendicularly to control sleeve 61, pump barrel 71 and plunger shaft 51. Control rod 62 may also have teeth (not shown) for interacting with the teeth of control sleeve 61.

Pumping chamber 42 may be arranged within an upper part of pump barrel 71. Pumping chamber 42 may be connected to a fuel supply gallery 41 via fuel ports 72. Fuel supply gallery 41 may be an annular space concentrically arranged within pump housing 31 and around an upper part of pump barrel 71. Fuel supply gallery 41 again may be connected to a fuel inlet opening and a fuel outlet opening (not shown) through which fuel may enter or exit fuel supply gallery 41.

On the level where fuel supply gallery 41 is located in fuel pump 1, pump housing 31 may be provided with two baffle body holes 33 (one on the right side and one on the left side of pump housing 31 in FIG. 1). Baffle body holes 33 may extend in the right-left-direction through an upper part of pump housing 31, possibly opposite fuel ports 72. Alternatively, fuel pump 1 may also be provided with one or more than two baffle body holes 33, depending on the number of fuel ports 72.

In each baffle body hole 33, a baffle body 80, such as a baffle screw, may be positioned. Baffle body 80 may extend from the outside to the inside of pump housing 31 such that it protrudes into fuel supply gallery 41. In particular, each of baffle bodies 80 may be positioned directly opposite to one of fuel ports 72 such that there is a small gap between each end of fuel port 72 at an outer side of pump barrel 71 and the end surface of baffle body 80 protruding into fuel supply gallery 41.

FIG. 2 shows baffle body 80 in more detail. Baffle body 80 may have a baffle body shaft 90, a baffle body head 95 arranged at one end of the baffle body shaft 90 and an insert element 100. In FIG. 2, baffle body shaft 90 and insert element 100 are depicted separately. Baffle body shaft 90 and/or baffle body head may be made of steel or any other hard metal.

Baffle body shaft 90 may have a first end, which is, in an assembled state, exposed to the inside of pump housing 31 and, thus, to the fuel in fuel supply gallery 41. In the following, the first end will be referred to as a fuel exposed shaft end 91. Further, baffle body shaft 90 may have a second end, which is opposed to the fuel exposed shaft end 91 and, thus, faces baffle body head 95 of baffle body 80. In the following, the second end will be referred to as a head facing shaft end 92. Furthermore, baffle body shaft 90 may be provided with a male thread 94 along its whole length. Alternatively, baffle body shaft 90 may be partially provided with a male thread. Further, baffle body shaft 90 may be provided with a shaft opening 93 at fuel exposed shaft end 91. Shaft opening 93 may extend substantially along the whole length of baffle body shaft 90. Alternatively, shaft opening 93 may also extend partially along the length of baffle body shaft 90. Shaft opening 93 may have a circular, a rectangular, or any other cross section.

Baffle body head 95 may be formed as a screw head. Alternatively, baffle body head 95 may have any other suitable shape. A through hole 96 may be formed through baffle body head 95 such that it extends from the outside of baffle body head 95 to shaft opening 93. Through hole 96 may be a straight hole, but may also be a curved hole or the like. Through hole 96 may be provided with a headless screw (not shown) or may be closed with any other suitable element, for example, a metal plug. Further, through hole 96 may be provided with a sensor (not shown), for example, a flow sensor for detecting fuel leaking through shaft opening 93 when insert element 100 is in an assembled state. Alternatively, the sensor may also be connected to through hole 96.

Insert element 100 may be made of a wear resistant material, for example ceramic or ceramic and HIP (Hot Isotactic Pressure) processed ceramic. Ceramic has excellent wear resistant properties, a closed surface structure and, due to reduced Van-der-Waals-forces, reduced adhesion forces, for example, around 20 mN/m, preventing fuel-build-up at its outer surface. Alternatively, insert element 100 may also be made of any other material, for example, a ceramic-like material having excellent wear resistance properties, a closed surface structure and reduced Van-der-Waals-forces. Insert element 100 may have an impact absorbing portion 104 with an impact absorbing surface 105. In the embodiment shown in FIG. 2, impact absorbing surface 105 is a plane, flat surface. Further, insert element 100 may have an insert element shaft 103. Insert element shaft 103 may be configured for insertion in opening 93 of baffle body 80, for example, insert element shaft 103 may have a tapered end portion 101 at one end thereof. Further, insert element 103 may have a head facing end portion 102 at the other end thereof. Head facing end portion 102 may be arranged at the surface of impact absorbing portion 104 opposing impact absorbing surface 105. Impact absorbing portion 104 may have a greater cross-section than insert element shaft 103. Alternatively, impact absorbing portion 104 may have the same cross-section as insert element shaft 103.

Wear resistant insert element 100 may be in a fixed position with respect to the baffle body shaft 90 and may at least partly reach into the shaft opening 93. In an assembled state, wear resistant insert element 100 may be not moveable in the direction of insertion. For example, said fixed position of wear resistant insert element 100 in shaft opening 93 may be achieved by end portion 104 configured to abut against a rear wall of shaft opening 93, a lateral wall (circumferential wall) configured to abut against an inner wall of shaft opening 93, and/or a shoulder configured to abuts against an annular wall around shaft opening 93 at fuel exposed shaft end 92 of baffle body shaft 90. One skilled in the art will appreciate that various further techniques for axially fixing wear resistant insert element 100 in shaft opening 93 may exist, which could be used instead of or additionally to the above described ones. To disassemble baffle body 80, wear resistant insert element 100 may be pulled in the direction oppositely directed to the insertion direction.

When assembling baffle body 80, indicated by an arrow pointing from the right to the left in FIG. 2, insert element shaft 103 may be arranged within shaft opening 93 such that tapered end portion 101 of insert element shaft 103 is introduced into shaft opening 93. In other words, in an assembled state, tapered end portion 101 abuts against a rear wall of shaft opening 93, i.e., a wall of shaft opening 93 extending perpendicularly to the longitudinal direction of shaft opening 93 (left-right-direction in FIG. 2) at head facing shaft end 92. In case impact absorbing portion 104 has a larger cross-section than insert element shaft 103, impact absorbing portion may cover fuel exposed shaft end 91 of baffle body shaft 90 in assembled state. Conversely, in case impact absorbing portion 104 has the same cross section as insert element shaft 103, impact absorbing portion 104 may cover part of fuel exposed shaft end 91 such that, for example, an annular portion of fuel exposed shaft end 91 stays uncovered. Prior to assembling baffle body shaft 90 and insert element 100 together, baffle body shaft 90 may be heated such that the cross-section of opening 93 is widened and insert element 100 may be cooled such that the cross-section of insert element shaft 103 is reduced. After assembling, baffle body shaft 90 and insert element 100 may return to the surrounding temperature such that the cross-section of opening 93 is reduced and the cross-section of insert element shaft 103 is widened. In this way, not only an easy assembling of baffle body shaft 90 and insert element 100, but also a reliable fit (press fit) between the two components may be realized. Alternatively, opening 93 may be provided with a female thread and insert element shaft 103 may be provided with a male thread such that both components may be screwed with each other such that head facing end portion 102 abuts against fuel exposed shaft end 91. In this case, insert element 100 may be secured by applying a fastening torque, for instance, to impact absorbing portion 104, for example by use of a spanner or wrench (see portion of insert element 100 indicated with crossed lines in FIGS. 2 to 6B).

FIGS. 3A and 3B show a second embodiment of insert element 100. According to the second embodiment of insert element 100, impact absorbing surface 105 may be provided with a conical portion 106, 106′. Conical portion 106 may extend substantially over the whole impact absorbing surface 105 and encompass an obtuse angle, as shown in FIG. 3A. Alternatively, conical portion 106′ may also only extend over a part of impact absorbing surface 105 and encompass an acute angle, as shown in FIG. 3B. Further, conical portion 106, 106′ may instead have a truncated end instead of a pointed end such that it forms a truncated cone.

FIGS. 4A and 4B show a third embodiment of insert element 100. According to the third embodiment of insert element 100, impact absorbing surface 105 may be provided with a part-domed portion such as a part-spherical portion 107, 107′. Part-spherical portion 107 may extend over a part of impact absorbing surface 105, and may have a small radius, as shown in FIG. 4A. Alternatively, part-spherical portion 107′ may also extend over a wide range of the impact absorbing surface 105 or substantially the whole impact absorbing surface 105 and may have a large radius, as shown in FIG. 4B. Alternatively, part-domed portion may not be exactly spherical, but may also be elliptical or oval such that it is in the form of a part-elliptical or a part-oval portion.

FIGS. 5A and 5B show a fourth embodiment of insert element 100. According to the fourth embodiment of insert element 100, impact absorbing surface 105 may be provided with a part-domed portion such as a portion 108, 108′ having a part-spherical cavity. Portion 108 may extend over a part of impact absorbing surface 105 and part-spherical cavity may have a small radius, as shown in FIG. 5A. Alternatively, portion 108′ may extend over substantially the whole impact absorbing surface 105 and the part-spherical cavity may have a large radius, as shown in FIG. 5B. Alternatively, the part-domed cavity may also be formed as a part-elliptic or a part-oval cavity. Further, the part-domed, i.e., the part-spherical, part-elliptic or part-oval cavity may also be formed directly into impact absorbing portion 104 from impact absorbing surface 105 such that it is formed towards insert element shaft 103.

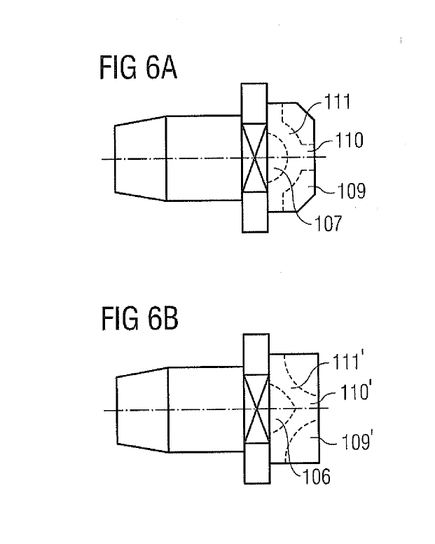

FIGS. 6A and 6B show a fifth embodiment of insert element 100.

According to the fifth embodiment of insert element 100, impact absorbing surface 105 may be provided with a part-spherical portion 107, as shown in FIG. 6A, or a conical portion, as shown in FIG. 6B, and, additionally, with a cover 109, 109′. Cover 109, 109′ may be spaced from spherical portion 107 and conical portion 106, respectively, such that a fuel flow passage 111, 111′ is formed between spherical portion 107 and conical portion 106, respectively. Further, cover 109 may be provided with a cover opening 110 and cover 109′ may be provided with a cover opening 110′. Cover opening 110, 110′ may be positioned in the middle of cover 109, 109′ in a direction perpendicular to the longitudinal direction of insert element 100, but may also be arranged at any other position on cover 109, 109′. Alternatively, impact-absorbing surface 105 may be provided with a truncated cone, a part-elliptic or part-oval portion and a cavity as described with respect to FIGS. 5A and 5B, respectively, and a cover as described above.

Conical portion 106, 106′, part-spherical portion 107, 107′, portion 108, 108′ with part-spherical cavity and cover 109, 109′ may be made of ceramic or a ceramic-like material as insert element 100 and may form part of impact absorbing surface 105. Further, impact absorbing surface 105 may also be provided with a combination of conical portion 106, 106′, part-spherical portion 107, 107′, portion 108, 108′ with part-spherical cavity and/or cover 109, 109′.

### INDUSTRIAL APPLICABILITY

During operation of fuel pump 1, fuel stored in a fuel reservoir, such as a tank (not shown), may enter fuel pump 1, in particular, fuel supply gallery 41, via the fuel inlet opening (not shown).

Depending on the load condition (acceleration, constant speed driving, deceleration), the engine may require different fuel supply volumes. Accordingly, the volumes of fuel supplied to a fuel injector may have to be adjusted as soon as the load condition and, thus, the engine load is changed. For adjusting the fuel supply volume, plunger 50 may be provided with control edge 52 which may be formed as a groove which is obliquely arranged along the circumference at an upper end of plunger shaft 51 and which may be in communication with a pumping chamber 42 and at least one of ports 72 for discharging surplus fuel. By rotating plunger 50 around its longitudinal axis, the stroke of a plunger 50 until control edge 52 may establish a communication between pumping chamber 42 and at least one of ports 72 for discharging surplus fuel may be changed. For rotating plunger 50, plunger 50 may have at least one control element (not shown) connected to control sleeve 61 which is configured to be rotatable by control rod 62 engaging control sleeve 61 via teeth.

From the fuel inlet opening, the fuel may flow into fuel supply gallery 41 and from fuel supply gallery 41 through ports 72 into pumping chamber 42.

In pumping chamber 42, the fuel may be pressurized and supplied upwards to a combustion chamber of an engine (not shown) by plunger 50 reciprocating in pumping chamber 42. The reciprocating movement of plunger 50 may be caused by a camshaft (not shown) of the engine. As soon as the camshaft is rotating, a tappet body in tappet body carrier 21 and plunger 50 may be lifted in the direction of pumping chamber 42 by the upward movement of the roller once per revolution of the camshaft and lowered to its initial position via the biasing force of a pump spring (not shown) concentrically arranged around control sleeve 61 in a lower portion of pump housing 31 in the longitudinal direction of fuel pump 1.

Depending on the current load condition, the engine may need more or less fuel to respond to operative load changes. For instance, when an operator increases the load of the engine and, for example, requires acceleration, the engine may need more fuel than may be otherwise needed if the operator selects to drive the engine with a constant speed and load (steady operation). Conversely, when the operator reduces the load or driving speed, the engine may need less fuel than may otherwise be required if the operator maintains steady operation of the engine.

The volume of fuel supplied from fuel pump 1 to the combustion chamber of the engine is controlled by control mechanism 60. For example, control rod 62 may be connected to a governor (not shown) and may be operated linearly, in case the operator changes the speed/load of the engine. The governor may be an engine speed controller, which may operate control rod 62 by comparing a current engine speed with a target engine speed. As a control rod 62 may engage control sleeve 61 via teeth, control sleeve 61 is rotated if control rod 62 is linearly moved. Further, as plunger 50 is connected with control sleeve 61 via the control element, plunger 50 may also be rotated.

Due to the rotation of plunger 50, control edge 52 may be displaced towards or away from one of ports 72. Through control edge 52, surplus fuel (which is not supplied to the engine) may be discharged via at least one of ports 72, fuel supply gallery 41 and the fuel outlet opening into the tank. As control edge 52 may be formed as a curved groove, the stroke of plunger 50, required such that fuel may flow from the pumping chamber 42 through the control edge 52 (surplus fuel), may change with the rotation of plunger 50. For example, in case plunger 50 is rotated clockwise (when viewed from the top), more fuel may be supplied from fuel pump 1 to the combustion chamber of the engine than in case plunger 50 is rotated counter-clockwise. In other words, the earlier control edge 52 overlaps the ports 72, the less fuel is supplied to the engine and vice versa.

When control edge 52 passes one of fuel ports 72, pressure in pumping chamber 42 is relieved, because, on the one hand, the fuel in pumping chamber 42 is stopped to be supplied to the engine and, on the other hand, control edge 52 establishes a communication between pumping chamber 41 and fuel port 72 such that the highly pressurized fuel in pumping chamber 42 is transmitted via fuel ports 72 to fuel supply gallery 41 as a pressure wave. The pressure wave moves with high speed causing an evaporation of the fuel and a formation of cavitation in the fuel. Accordingly, the pressure wave may also be referred to as a pressure/cavitation wave.

To absorb the energy of the pressure/cavitation wave or at least to reflect and throw back, respectively, part of pressure/cavitation wave to pump barrel 71, at least one baffle body 80 may protrude in fuel supply gallery 41. As shown in FIG. 1, baffle body 80 may be screw-like. However, baffle body 80 may also be any other type of component configured to protrude into fuel supply gallery 41 in order to absorb most of the energy of the above-described pressure/cavitation wave or at least reflect part of the pressure/cavitation wave.

As baffle body 80 may have wear resistant insert element 100, improvements may be made to its wear resistance, resistance against fuels with low pH-values such as alternative fuels or low sulfur fuels and resistance against fuel-build-up covering the surface of baffle body 80. Specific shapes of the impact absorbing surface 105, as shown in FIGS. 2 to 6B, may reliably reduce the energy of the pressure wave, in particular, via cover opening 110, 110′ and fuel flow passages 111, 111′. In particular, the shapes of impact absorbing surface 105, as shown in FIGS. 2 to 5B, may serve for at least partially absorbing the energy of the fuel pressure/cavitation wave and, additionally, for widely spreading the fuel pressure/cavitation wave such that the part of the fuel pressure/cavitation wave which is not absorbed by baffle body 80, but thrown back to pump barrel 71, may impact on a wide surface portion of the outer surface of pump barrel 71. The wider the surface portion is on which the fuel pressure/cavitation wave impacts, the lower the damage of the outer surface of pump barrel 71 is and, thus, the longer the life-time of pump barrel 71 is. Further, the shapes of impact absorbing surface 105, as shown in FIGS. 6A and 6B, may serve for at least partially absorbing the energy of the fuel pressure/cavitation wave and for preventing a throw-back of the fuel pressure/cavitation wave to pump barrel 71 by use of cover 109, 109′. Namely, in that the fuel pressure/cavitation wave enters cover opening 110, 110′, fuel pressure/cavitation wave is at least partially absorbed and the part of fuel pressure/cavitation wave which is not absorbed impacts on an inner surface portion of cover 109, 109′ itself.

As wear resistant insert element 100 is made of ceramic, it may be built stable and may not be subjected to cavitations, for example, to core formation by negative pressure due to the pressure wave in fuel pump 1 occurring with each pumping operation.

Furthermore, as wear resistant insert elements 100 is made of ceramic, it may have reduced Van-der-Waals-forces, for example, reduced surface adhesion forces, such that fuel in fuel supply gallery 41 sticks less to the surface of ceramic insert element 100 and, hence, reduces fuel build-up (polymerization of fuel) covering the end surface of baffle body 80 protruding into fuel supply gallery 41.

Further, as baffle body 80 may have through hole 96 in baffle body head 95, air within shaft opening 93 of baffle body 80 may easily escape from shaft 90 when insert element 100 is inserted into baffle body shaft 90. After assembling insert element 100 to baffle body shaft 90, through hole 96 may be closed with the headless screw for preventing the entry of dirt and/or dust. Additionally or alternatively, a sensor (not shown) may be arranged within or connected to through hole 96, in order to monitor whether fuel leaks between insert element 100 and shaft 90, i.e., through shaft opening 93 and through hole 96.

Finally, insert element 100 may be replaced separately, i.e., without replacing baffle body shaft 90, in case a differently shaped insert element 100 compared to the actually used insert element 100 should be used or in case insert element 100 has to be replaced due to conspicuous wear at its energy absorbing surface 105.

In some embodiments, insert element 100 may comprise an insert element shaft 103 arranged at impact absorbing portion 104 and configured for insertion in opening 93 of baffle body 80.

In some embodiments, impact absorbing portion 104 may have a greater cross-section than insert element shaft 103.

In some embodiments, impact absorbing surface 105 may be a plane surface.

In some embodiments, impact absorbing surface 105 may have conical portion 106, 106′ and/or part-domed portion 107, 107′ and/or a portion 108, 108′ having a part-domed cavity.

In some embodiments, impact absorbing surface 105 may have cover 109, 109′ with cover opening 110, 110′. Cover 109, 109′ may be spaced from impact absorbing surface 105 such that fuel flow passage 111, 111′ is provided between impact absorbing surface 105 and cover 109, 109′.

In some embodiments, insert element 100 may be made of ceramic.

In some embodiments, absorbing the energy of a pressure wave generated during pumping operation of fuel pump 1 by impact absorbing surface 105 may be facilitated due to at least configuring impact absorbing surface 105 and impact absorbing portion 104 to be gradually removed by abrasion if a pressure wave impinges on impact absorbing surface 105. In other words, impact absorbing surface 105 and impact absorbing portion 104 may function as a sacrificial abrasion reservoir to absorb the energy of the pressure waves. In case an insert element 100 may be worn, it can be easily replaced by a new one.

In some embodiments, baffle body 80 may be configured to be positioned in fuel pump 1 at a position towards which, during operation of the fuel pump 1, a pressure wave propagates such that the impact absorbing surface 105 of the wear resistant insert element 100 is exposed to the pressure wave for at least partially absorbing the energy of the pressure wave.

In some embodiments, baffle body 80 may further comprise baffle body head 95 arranged at baffle body shaft 90. Baffle body shaft 90 may be at least partially provided with male thread 94 along its length.

In some embodiments, baffle body head 95 may have through hole 96 extending from the outside of baffle body head 95 to shaft opening 93, and optionally may be at least partially provided with a female thread.

In some embodiments, baffle body 80 may further comprise a sensor for detecting fuel leaking through hole 96.

In some embodiments, baffle body shaft 90 and/or baffle body head 95 may be made of steel.

Although the preferred embodiments of this invention have been described herein, improvements and modifications may be incorporated without departing from the scope of the following claims.

1. Baffle body for a plunger operated fuel pump,
the baffle body comprising:
a baffle body shaft, which has a fuel exposed shaft end with a shaft opening, and
a wear resistant insert element in a fixed position with respect to the baffle body shaft and at least partly reaching into the shaft opening, and comprising an impact absorbing portion with an impact absorbing surface, the impact absorbing surface being configured to at least partially absorb the energy of a pressure wave generated during pumping operation of the fuel pump.

2. Baffle body of claim 1, wherein the wear resistant insert element comprises at least one of:
an end portion configured to abut against a rear wall of shaft opening;
a lateral wall configured to abut against an inner wall of shaft opening;
or
a shoulder configured to abut against an annular wall around shaft opening at the fuel exposed shaft end of the baffle body shaft.

3. Baffle body for a plunger operated fuel pump, the baffle body comprising:
a baffle body shaft which has a fuel exposed shaft end with a shaft opening, and
a wear resistant insert element inserted into the shaft opening, the wear resistant insert element comprising:
a tapered end portion, which abuts against a rear wall of shaft opening; and
an impact absorbing portion with an impact absorbing surface, the impact absorbing surface being configured to at least partially absorb the energy of a pressure wave generated during pumping operation of the fuel pump.

4. Baffle body of claim 1, wherein the impact absorbing surface and the impact absorbing portion are configured to be gradually removed by abrasion if a pressure wave impinges on the impact absorbing surface.

5. Baffle body of claim 1, further comprising an insert element shaft arranged at the impact absorbing portion and configured for insertion in the shaft opening of the baffle body.

6. Baffle body of claim 5, wherein the impact absorbing portion has a greater cross-section than the insert element shaft.

7. Baffle body of claim 1, wherein the impact absorbing surface is a plane surface.

8. Baffle body of claim 6, wherein the impact absorbing surface has one of a conical portion a part-domed portion or a portion having a part-domed cavity.

9. Baffle body of claim 7, wherein the impact absorbing surface has a cover with a cover opening, the cover being spaced from the impact absorbing surface such that a fuel flow passage is provided between the impact absorbing surface and the cover.

10. Baffle body of claim 1, wherein the wear resistant insert element is made of ceramic.

11. Wear resistant insert element configured to be inserted into an opening of a baffle body for a plunger operated fuel pump, the wear resistant insert element comprising
an impact absorbing portion with an impact absorbing surface, the impact absorbing surface being configured to at least partially absorb the energy of a pressure wave generated during pumping operation of the fuel pump, and the impact absorbing surface and the impact absorbing portion being configured to be gradually removed by abrasion if a pressure wave impinges on the impact absorbing surface.

12. Wear resistant insert element configured to be inserted into an opening of a baffle body for a plunger operated fuel pump, the wear resistant insert element comprising
an impact absorbing portion with an impact absorbing surface, the impact absorbing surface being configured to at least partially absorb the energy of a pressure wave generated during pumping operation of the fuel pump.

13. Wear resistant insert element of claim 12, further comprising an insert element shaft arranged at the impact absorbing portion and configured for insertion in the opening of the baffle body.

14. Wear resistant insert element of claim 11, wherein the impact absorbing portion has a greater cross-section than the insert element shaft.

15. Wear resistant insert element of claim 11, wherein the impact absorbing surface is a plane surface.

16. Wear resistant insert element of claim 15, wherein the impact absorbing surface has one of a conical portion a part-domed portion or a portion having a part-domed cavity.

17. Wear resistant insert element of claim 15, wherein the impact absorbing surface has a cover with a cover opening, the cover being spaced from the impact absorbing surface such that a fuel flow passage is provided between the impact absorbing surface and the cover.

18. Wear resistant insert element of claim 12, wherein the wear resistant insert element is made of ceramic.

19. Baffle body for a plunger operated fuel pump, the baffle body comprising:
a baffle body shaft which has a fuel exposed shaft end with a shaft opening, and
a wear resistant insert element which is inserted into the shaft opening, the wear resistant insert element comprising an impact absorbing portion with an impact absorbing surface, the impact absorbing surface being configured to at least partially absorb the energy of a pressure wave generated during pumping operation of the fuel pump, and the impact absorbing surface and the impact absorbing portion being configured to be gradually removed by abrasion if a pressure wave impinges on the impact absorbing surface.

20. Baffle body of claim 19, wherein the baffle body is configured to be positioned in the fuel pump at a position towards which, during operation of the fuel pump, a pressure wave propagates such that the impact absorbing surface of the wear resistant insert element is exposed to the pressure wave for at least partially absorbing the energy of the pressure wave.

21. Baffle body of any on of claim 20, further comprising a baffle body head arranged at the baffle body shaft, the baffle body shaft being at least partially provided with a male thread along its length.

22. Baffle body of claim 21, wherein the baffle body head has a through hole extending from the outside of the baffle body head to the shaft opening, and optionally is at least partially provided with a female thread.

23. Baffle body of claim 22, further comprising a sensor for detecting fuel leaking through the through hole.

24. Baffle body of claim 19, wherein the baffle body shaft and/or the baffle body head are made of steel.

25. Fuel pump for an internal combustion engine, the fuel pump comprising
a pump housing,
a barrel within the housing,
a fuel supply gallery defined between the housing and the barrel,
a pumping chamber defined within the barrel,
at least one fuel port connecting the pumping chamber with the fuel supply gallery, and
a plunger configured to move within the barrel,
wherein at least one baffle body is positioned in the pump housing such that it protrudes into the fuel supply gallery at a position where, during pumping operation of the fuel pump, a pressure wave propagates towards the pump housing, the at least one baffle body comprising:
a baffle body shaft, which has a fuel exposed shaft end with a shaft opening, and
a wear resistant insert element in a fixed position with respect to the baffle body shaft and at least partly reaching into the shaft opening, and comprising an impact absorbing portion with an impact absorbing surface, the impact absorbing surface being configured to at least partially absorb the energy of a pressure wave generated during pumping operation of the fuel pump wherein the impact absorbing surface of the baffle body is preferably positioned opposite to the fuel port.

26. Method for increasing the wear resistance of a plunger operated fuel pump in which a fuel pressure wave is generated during pumping operation, the method comprising:
providing a baffle body comprising:
a baffle body shaft, which has a fuel exposed shaft end with a shaft opening, and
a wear resistant insert element in a fixed position with respect to the baffle body shaft and at least partly reaching into the shaft opening, and comprising an impact absorbing portion with an impact absorbing surface, the impact absorbing surface being configured to at least partially absorb the energy of a pressure wave generated during pumping operation of the fuel pump; and
arranging the baffle body within a pump housing of the fuel pump such that the baffle body protrudes inside of the fuel pump at a position where, during pumping operation of the fuel pump, a pressure wave propagates towards the pump housing.
